(19) United States
(12) Patent Application Publication
(10) Pub. No.: US 2017/0240015 A1
(43) Pub. Date: Aug. 24, 2017

(54) BUMPER RUBBER FOR SHOCK ABSORBER

(71) Applicant: MANDO CORPORATION, Pyeongtaek-si (KR)

(72) Inventor: Jeong Ho IM, Iksan-si (KR)

(21) Appl. No.: 15/435,867

(22) Filed: Feb. 17, 2017

(30) Foreign Application Priority Data
Feb. 19, 2016 (KR) 10-2016-0019455

(51) Int. Cl. B60G 11/22; F16F 15/08; F16F 1/377

(52) U.S. Cl. CPC B60G 11/22; F16F 1/377; F16F 15/08; B60G 2202/143; F16F 2232/08; F16F 2236/04; F16F 2222/04

(57) ABSTRACT

A bumper rubber for a shock absorber includes: a body portion in which a cylindrical coupling hole vertically penetrates such that a piston rod is connected thereto; one or more inner grooves formed concavely along a circumferential direction of the coupling hole and arranged in a vertical direction; and an inner protrusion protruding from an inner peripheral surface of the inner groove radially inward, wherein a laterally protruding end of the inner protrusion comes into close contact with an outer surface of the piston rod when the body portion is vertically compressed.

### CROSS-REFERENCE(S) TO RELATED APPLICATION

This application claims the benefit of Korean Patent Application No. 10-2016-0019455, filed on Feb. 19, 2016, in the Korean Intellectual Property Office, the disclosure of which is incorporated herein in its entirety by reference.

### BACKGROUND OF THE INVENTION

Field of the Invention

The present invention relates to a bumper rubber for a shock absorber, and more particularly, to a bumper rubber for a shock absorber, in which an inner protrusion protrudes from an inner peripheral surface of an inner groove and thus a protrusion length of the inner protrusion is reduced, thereby minimizing friction joint between a piston rod and the bumper rubber.

Description of the Related Art

Generally, a shock absorber is designed to suppress or reduce a vibration from a road surface. The shock absorber is mounted between a vehicle body or frame and a wheel to absorb vertical vibration energy of a vehicle body.

The shock absorber can increase a durability life by reducing dynamic stress of each part of a vehicle body, can ensure roadholding performance of a tire by suppressing a motion of unsprung mass, and can improve motion performance of a vehicle by suppressing a posture change due to an inertial force.

The shock absorber includes a cylinder, a piston valve performing compression and rebound strokes within the cylinder, a piston rod having one end connected to the piston valve and the other end connected to the vehicle body, and a bumper rubber absorbing a shock between the cylinder and the piston rod.

The buffer rubber includes a coupling hole to which the piston rod is connected, and the buffer rubber is made of a material such as rubber, so as to enable compression and relaxation during strokes.

However, when the buffer rubber is compressed by a force applied in a vertical direction and the inner peripheral surface thereof is expanded radially inward, a contact pressure between the bumper rubber and the piston rod may be excessively applied, thus causing friction joint.

Also, when the contact pressure between the bumper rubber and the piston rod during compression is increased, the inner peripheral surface of the bumper rubber may be worn out. In this case, the bumper rubber may be moved, or the shock-absorbing performance may be degraded.

As one of prior art documents related to the present invention, Korean Patent Application Publication No. 10-2002-0045773 (published on Jun. 20, 2002) discloses a bumper assembly for a shock absorber.

### SUMMARY OF THE INVENTION

An aspect of the present invention provides a bumper rubber for a shock absorber, in which an inner protrusion protrudes from an inner peripheral surface of an inner groove and thus a protrusion length of the inner protrusion is reduced, whereby, when the bumper rubber is compressed, a contact pressure between a piston rod and the inner protrusion can be reduced, thereby minimizing friction joint between the piston rod and the bumper rubber.

According to an embodiment, a bumper rubber for a shock absorber includes: a body portion in which a cylindrical coupling hole vertically penetrates such that a piston rod is connected thereto; one or more inner grooves formed concavely along a circumferential direction of the coupling hole and arranged in a vertical direction; and an inner protrusion protruding from an inner peripheral surface of the inner groove radially inward, wherein a laterally protruding end of the inner protrusion comes into close contact with an outer surface of the piston rod when the body portion is vertically compressed.

The inner grooves may be continuously formed along the circumferential direction of the coupling hole, and a plurality of inner protrusions may be arranged along a circumferential direction of the inner grooves.

The inner groove may be formed to have a concavely curved surface along a vertical direction of the coupling hole.

The protruding end of the inner protrusion may form a convexly curved surface in the vertical direction and the circumferential direction of the coupling hole.

The inner protrusion may be formed to have an oval surface with a length along the vertical direction of the coupling hole.

The protruding end of the inner protrusion may further protrude radially inward than upper and lower ends of the inner groove.

The inner protrusion may be inclined in the circumferential direction of the coupling hole so as to form a helical shape along the vertical direction of the coupling hole.

Outer grooves may be continuously formed on the outer surface of the body portion along the circumferential direction, and the outer grooves may be disposed in a section between the upper end and the lower end of the inner groove.

An air passage may be concavely formed at the upper end of the body portion such that air inside the coupling hole is ventilated to the outside, one end of the air passage may communicate with the coupling hole, and the other end of the air passage may communicate with the outside of the body portion.

The air passage may include: a horizontal portion formed concavely at the upper end of the body portion, one end of the horizontal portion communicating with the coupling hole, the other end of the horizontal portion communicating with the outside of the body portion; and a vertical portion extending to be bent downward from the one end of the horizontal portion, and formed concavely on the outer surface of the body portion.

The bumper rubber may further include one or more upper protrusions on the inner peripheral surface of the coupling hole, wherein the one or more upper protrusions may be spaced apart from each other in an upper portion of the inner groove and come into contact with the outer surface of the piston rod, and the upper protrusions may be disposed on the same line as the air passage with respect to a vertical central line of the coupling hole.

The bumper rubber may further include a contact end in a lower side of the body portion, wherein the contact end may be curvedly bent toward a central axis of the coupling hole, a lower portion of the contact end may come into close contact with an upper end of the cylinder, and a plurality of outer protrusions may be arranged on an outer surface of the contact end along a circumferential direction so as to come into close contact with the upper end of the cylinder when the bumper rubber is compressed.

The outer surface of the contact end may be formed to have a convexly curved surface in the vertical direction, and the outer protrusion may form a convexly curved surface in the vertical direction and the circumferential direction.

### BRIEF DESCRIPTION OF THE DRAWINGS

FIG. 1 is a perspective view of a bumper rubber for a shock absorber according to the present invention.

FIG. 2 is a cross-sectional view of the bumper rubber for the shock absorber according to the present invention.

FIG. 3 is a cross-sectional view illustrating a state in which an inner protrusion is obliquely formed in the bumper rubber for the shock absorber according to the present invention.

FIG. 4 is a perspective view illustrating a state in which an outer protrusion is further formed in the bumper rubber for the shock absorber according to the present invention.

### DETAILED DESCRIPTION OF EMBODIMENTS

Hereinafter, preferred embodiments of the present invention will be described in detail with reference to the accompanying drawings.

The advantages and features of the present invention and methods for achieving them will become more apparent from the following embodiments that are described in detail in conjunction with the accompanying drawings.

However, it should be understood that the present invention is not limited to the following embodiments, and various modifications can be made without departing from the scope of the present invention. The embodiments set forth herein are provided so that this disclosure will be thorough and complete, and will fully convey the concept of the invention to those skilled in the art. The present invention should be defined by the appended claims.

In addition, detailed descriptions of well-known technologies or the like will be omitted since they would unnecessarily obscure the subject matters of the present invention.

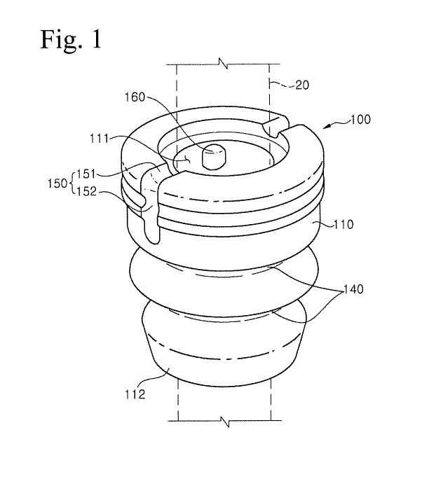

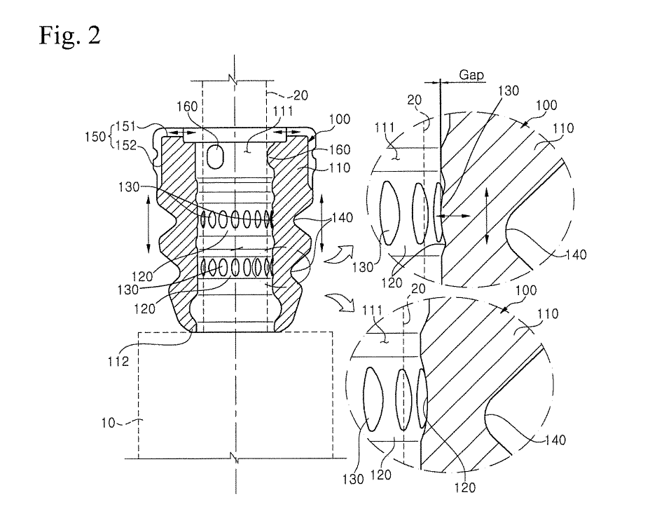

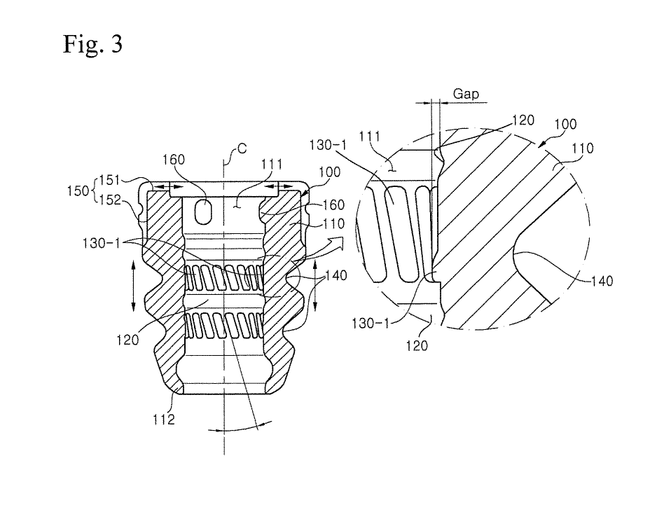

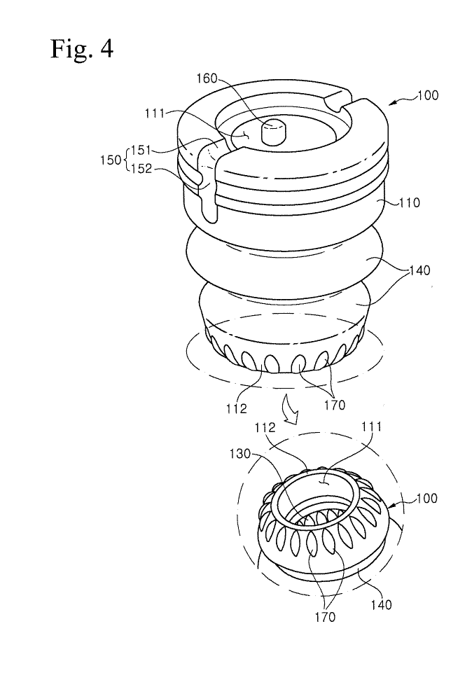

FIG. 1 is a perspective view of a bumper rubber for a shock absorber according to the present invention, FIG. 2 is a cross-sectional view of the bumper rubber for the shock absorber according to the present invention, FIG. 3 is a cross-sectional view illustrating a state in which an inner protrusion is obliquely formed in the bumper rubber for the shock absorber according to the present invention, and FIG. 4 is a cross-sectional view illustrating a state in which an outer protrusion is further formed in the bumper rubber for the shock absorber according to the present invention.

Referring to FIGS. 1 and 2, the shock absorber according to the present invention includes a cylinder 10, a piston rod 20, and a bumper rubber 100.

The shock absorber according to the present invention further includes a piston valve (not illustrated) in the cylinder 10 in a state of being connected to one end of the piston rod 20, such that the inside of the cylinder 10 is divided into a compression chamber and a rebound chamber.

Also, the shock absorber according to the present invention may further include an upper structure (insulator or the like) (not illustrated) configured to fix the piston rod 20 to a vehicle body, a dust cover (not illustrated) configured to cover the bumper rubber 100 and the upper end of the cylinder 10 from the outside, and upper/lower spring sheets (not illustrated) respectively installed on the cylinder 10 and the insulator to support a helical suspension spring.

Among the above-described components, the cylinder 10 may have a cylindrical shape to form an internal space, and the internal space of the cylinder 10 is filled with a fluid (oil, etc.).

One end of the cylinder 10 and one end of the piston rod 20 described later may be respectively connected to the vehicle body side or the wheel side of the vehicle to perform compression and rebound strokes.

One end of the piston rod 20 may be connected to the piston valve (not illustrated), and the other end of the piston rod 20 may extend to the outside of the cylinder 10 and connect to the vehicle body side or the wheel side of the vehicle.

The piston valve divides the inside of the cylinder 10 into the compression chamber and the rebound chamber and generates a damping force due to resistance of a fluid while reciprocating within the cylinder 10 in a direction of the compression and rebound strokes.

The bumper rubber 100 is installed between a lower end of the upper structure and the cylinder 10 and absorbs a shock transferred in a vertical direction through compression and relaxation operations.

To this end, the bumper rubber 100 is made of an elastic shock-absorbing material, such as rubber, so that the bumper rubber 100 is relaxed to an original shape after absorbing a shock transferred in a vertical direction during compression.

In particular, the bumper rubber 100 includes a body portion 110, an inner groove 120, and a plurality of inner protrusions 130.

In the bumper rubber 100, the upper end of the body portion 110 is disposed on the upper structure side, and the lower end of the body portion 110 is disposed on the cylinder side. A coupling hole 111 vertically penetrates the body portion 110 such that the piston rod 20 vertically penetrates and connects to the coupling hole 111.

The coupling hole 111 may form a circumferential surface in the horizontal direction, and the coupling hole 111 may be formed to have an inner peripheral surface equal to or greater than a diameter of the piston rod 20.

When the bumper rubber 100 is compressed, the inner peripheral surface of the coupling hole 111 is expanded radially inward to come into close contact with the outer peripheral surface of the piston rod 20 with a certain pressure.

A lower end portion of the body portion 110 may have a shape in which a diameter thereof is gradually reduced. However, various shapes may be applied to the body portion 110.

The inner groove 120 is concavely formed along the inner peripheral surface of the coupling hole 111. One or more inner grooves 120 may be arranged along the vertical direction of the coupling hole 111.

It is preferable that the inner grooves 120 are continuously formed along the circumferential direction of the coupling hole 111, but the inner grooves 120 may be intermittently arranged along the circumferential direction of the coupling hole 111.

The inner groove 120 may be formed to have a concavely curved surface along the vertical direction of the coupling hole 111.

In this case, upper and lower ends of the inner groove 120 may be connected to the inner peripheral surface of the coupling hole 111 while forming a convexly curved surface.

For example, in a case where the plurality of inner grooves 120 are arranged along the vertical direction of the coupling hole 111, the adjacent ends of the inner grooves 120 may be connected to each other while forming a convexly curved surface.

The inner protrusions 130 are formed on the inner peripheral surface of the inner groove 120. The inner protrusions 130 protrude convexly from the inner peripheral surface of the inner groove 120 radially inward.

When the bumper rubber 100 is vertically compressed, the protruding ends of the inner protrusions 130 further protrude from the coupling hole 111 radially inward and come into close contact with the outer surface of the piston rod 20.

In this case, it is preferable that the plurality of inner protrusions 130 are arranged along the circumferential direction of the inner groove 120, but the inner protrusions 130 may be intermittently arranged along the circumferential direction of the inner groove 120.

The protruding ends of the inner protrusions 130 may be formed to have a convexly curved surface in the vertical direction and the circumferential direction of the coupling hole 111.

Since the inner protrusions 130 are disposed on the inner peripheral surface of the inner groove 120, the protruding ends of the inner protrusions 130 are spaced apart from the piston rod 20 by the depth of the inner groove 120.

As illustrated in FIGS. 1 and 2, the inner protrusions 130 may be formed to have an oval shape having a length along the vertical direction of the coupling hole 111.

As such, when the inner protrusions 130 are formed to have an oval shape, the protruding ends of the inner protrusions 130 may first come into close contact with the outer peripheral surface of the piston rod 20 with the smallest area.

The protruding ends of the inner protrusions 130 may further protrude radially inward than the upper and lower ends of the inner groove 120 and first come into close contact with the outer peripheral surface of the piston rod 20.

Unlike this, inner protrusions 130-1 may be formed to be inclined in the circumferential direction of the coupling hole 111 so as to form a helical shape along the vertical direction of the coupling hole 111.

As illustrated in FIG. 3, when the inner protrusions 130-1 are formed to be inclined, the inner protrusions 130-1 may have a length inclined in an oblique direction while forming the same width.

For example, when the bumper rubber 100 is compressed and the inner peripheral surface of the coupling hole 111 is expanded radially inward, the protruding ends of the inner protrusions 130-1 come into close contact with the outer peripheral surface of the piston rod 20 in the helical shape. Thus, due to the frictional force, the bumper rubber 100 can be rotated around the piston rod 20 by one pitch.

When the bumper rubber 100 is vertically compressed, the protruding ends of the inner protrusions 130 and 130-1 come into close contact with the outer peripheral surface of the piston rod 20.

In this case, since the inner protrusions 130 and 130-1 are disposed on the inner peripheral surface of the inner groove 120, it is possible to prevent a contact pressure between the piston rod 20 and the inner protrusions 130 and 130-1 from excessively rising above a certain range.

On the other hand, a concave outer groove 140 may be continuously formed on the outer surface of the body portion 110 along the circumferential direction. A plurality of concave outer grooves 140 may be arranged along the vertical direction.

The outer groove 140 may form a concavely curved surface in the vertical direction, and upper and lower ends of the outer groove 140 may be connected to form a convexly curved surface with the outer surface of the body portion 110.

As illustrated in FIG. 2, the outer groove 140 may be disposed in a section between the upper end and the lower end of the inner groove 120. In this case, a diameter of the outer groove 140 is relatively smaller than an outer diameter of the bumper rubber 100.

When the bumper rubber 100 is compressed, the outer groove 140 forms a section in which the bumper rubber 100 can greatly contract along the vertical direction.

In addition, an air passage 150 may be further formed concavely at the upper end of the body portion 110 such that air inside the coupling hole 111 can be ventilated to the outside.

The air passage 150 may be divided into a horizontal portion 151 formed horizontally, and a vertical portion 152 vertically connected to the horizontal portion 151.

The horizontal portion 151 is formed concavely at the upper end of the body portion 110. One end of the horizontal portion 151 communicates with the coupling hole 111, and the other end of the horizontal portion 151 communicates with the outside of the body portion 110.

That is, when the upper end of the bumper rubber 100 comes into close contact with the upper structure (insulator or the like), the bottom surface of the horizontal portion 151 is spaced apart from the upper structure, thereby maintaining the space in which air can move.

The vertical portion 152 extends to be bent downward in a state of being connected to one end of the horizontal portion 151 extending outward from the body portion 110. Thus, the vertical portion 152 is formed concavely on the outer surface of the body portion 110.

In this case, the vertical portion 152 has a certain length along the vertical direction and is exposed to the side of the body portion 110. Therefore, even when the bumper rubber 100 is compressed, the space in which air can move is maintained.

Since the air passage 150 communicates the coupling hole 111 with the outside and forms an air ventilation passage, the bumper rubber 100 can easily perform compression and relaxation operations.

In addition, one or more upper protrusions 160 may be further formed on the inner peripheral surface of the coupling hole 111. The upper protrusions 160 may be spaced apart from each other on the upper portion of the inner groove 120.

It is preferable that the protruding end of the upper protrusion 160 comes into close contact with the outer surface of the piston rod 20, but it may also be spaced apart from the outer surface of the piston rod 20 by a certain interval.

When the plurality of upper protrusions 160 are formed, one or more of the upper protrusions 160 may be disposed on the same line as the air passage 150 with respect to a vertical central axis line C of the plurality of coupling holes 111.

On the other hand, a contact end 112 may be formed in a lower portion of the body portion 110. The contact end 112 is curvedly bent toward the central axis of the coupling hole 111, and a lower portion of the contact end 112 comes into close contact with the upper end of the cylinder 10.

It is preferable that the contact end 112 is formed to have a curved surface so that the outer diameter of the contact end 112 is gradually reduced toward the lower portion. However, various shapes may be applied to the contact end 112.

In addition, as illustrated in FIG. 4, a plurality of outer protrusions 170 may be arranged on the outer surface of the contact end 112 along the circumferential direction such that the contact end 112 comes close contact with the upper end of the cylinder 10 when the bumper rubber 100 is compressed.

The outer protrusion 170 may be formed to have a convexly curved surface in the vertical direction and the circumferential direction. Specifically, the outer protrusion 170 may be formed to have an oval shape with a length along the vertical direction of the coupling hole 111.

That is, when the bumper rubber 100 is vertically compressed, the outer protrusion 170 comes into close contact with the upper end of the cylinder 10, thereby reducing a contact area between the cylinder 10 and the bumper rubber 100 and minimizing friction joint when the bumper rubber 100 is compressed.

Consequently, according to the present invention, since the inner protrusions 130 and 130-1 protrude from the inner peripheral surface of the inner groove 120, the protrusion length of the inner protrusions 130 and 130-1 is reduced. Therefore, when the bumper rubber 100 is compressed, the contact pressure between the piston rod 20 and the inner protrusions 130 and 130-1 can be reduced, thereby minimizing friction joint between the piston rod and the bumper rubber.

In addition, according to the present invention, since the contact pressure between the piston rod 20 and the bumper rubber 100 can be reduced, it is possible to prevent the contact surface of the bumper rubber 100 coming into close contact with the outer peripheral surface of the piston rod 20 from being rapidly worn out.

The bumper rubber for the shock absorber according to specific embodiments of the present invention have been described, but it is obvious that various modifications can be made thereto without departing from the scope of the present invention.

Therefore, the scope of the present invention should not be limited to the embodiments described above, and will be determined by the appended claims and equivalents thereof.

While the embodiments of the present invention have been described with reference to the specific embodiments, it will be apparent to those skilled in the art that various changes and modifications may be made without departing from the spirit and scope of the invention as defined in the following claims.

DESCRIPTION OF REFERENCE NUMERALS

| | |
|---|---|
| 10: cylinder | 20: piston rod |
| 100: bumper rubber | 110: body |
| 111: coupling hole | 112: contact end |
| 120: inner groove | 130, 130-1: inner protrusion |
| 140: outer groove | 150: air passage |
| 151: horizontal portion | 152: vertical portion |
| 160: upper protrusion | 170: outer protrusion |
| C: central axis line | |

What is claimed is:

1. A bumper rubber for a shock absorber, comprising:
a body portion in which a cylindrical coupling hole vertically penetrates such that a piston rod is connected thereto;
one or more inner grooves formed concavely along a circumferential direction of the coupling hole and arranged in a vertical direction; and
an inner protrusion protruding from an inner peripheral surface of the inner groove radially inward, wherein a laterally protruding end of the inner protrusion comes into close contact with an outer surface of the piston rod when the body portion is vertically compressed.

2. The bumper rubber according to claim 1, wherein the inner grooves are continuously formed along the circumferential direction of the coupling hole, and
a plurality of inner protrusions are arranged along a circumferential direction of the inner grooves.

3. The bumper rubber according to claim 2, wherein the inner groove is formed to have a concavely curved surface along a vertical direction of the coupling hole.

4. The bumper rubber according to claim 2, wherein the protruding end of the inner protrusion forms a convexly curved surface in the vertical direction and the circumferential direction of the coupling hole.

5. The bumper rubber according to claim 4, wherein the inner protrusion is formed to have an oval surface with a length along the vertical direction of the coupling hole.

6. The bumper rubber according to claim 2, wherein the protruding end of the inner protrusion further protrudes radially inward than upper and lower ends of the inner groove.

7. The bumper rubber according to claim 2, wherein the inner protrusion is inclined in the circumferential direction of the coupling hole so as to form a helical shape along the vertical direction of the coupling hole.

8. The bumper rubber according to claim 1, wherein outer grooves are continuously formed on the outer surface of the body portion along the circumferential direction, and
the outer grooves are disposed in a section between the upper end and the lower end of the inner groove.

9. The bumper rubber according to claim 1, wherein an air passage is concavely formed at the upper end of the body portion such that air inside the coupling hole is ventilated to the outside,
one end of the air passage communicates with the coupling hole, and
the other end of the air passage communicates with the outside of the body portion.

10. The bumper rubber according to claim 10, wherein the air passage comprises:
a horizontal portion formed concavely at the upper end of the body portion, one end of the horizontal portion communicating with the coupling hole, the other end of the horizontal portion communicating with the outside of the body portion; and
a vertical portion extending to be bent downward from the one end of the horizontal portion, and formed concavely on the outer surface of the body portion.

11. The bumper rubber according to claim 8, further comprising one or more upper protrusions on the inner peripheral surface of the coupling hole,
wherein the one or more upper protrusions are spaced apart from each other in an upper portion of the inner groove and come into contact with the outer surface of the piston rod, and
the upper protrusions are disposed on the same line as the air passage with respect to a vertical central line of the coupling hole.

12. The bumper rubber according to claim 1, further comprising a contact end in a lower side of the body portion,
wherein the contact end is curvedly bent toward a central axis of the coupling hole,
a lower portion of the contact end comes into close contact with an upper end of the cylinder, and
a plurality of outer protrusions are arranged on an outer surface of the contact end along a circumferential direction so as to come into close contact with the upper end of the cylinder when the bumper rubber is compressed.

13. The bumper rubber according to claim 12, wherein the outer surface of the contact end is formed to have a convexly curved surface in the vertical direction, and
the outer protrusion forms a convexly curved surface in the vertical direction and the circumferential direction.
